(19) United States
(12) Patent Application Publication
(10) Pub. No.: US 2005/0200043 A1
(43) Pub. Date: Sep. 15, 2005

(54) Transfer printing method for injection molding process

(75) Inventors: Charles Leu, Fremont, CA (US); Tai-Cherng Yu, Tu-Cheng (TW); Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/024,505

(22) Filed: Dec. 29, 2004

(30) Foreign Application Priority Data
Mar. 12, 2004 (TW) 93106643

(51) Int. Cl. B29C 45/00

(52) U.S. Cl. 264/132; 264/328.1

(57) ABSTRACT

A transfer printing method for an injection molding process includes the steps of: (a) providing a multi-channel ink-jet printer head comprising a Micro-Electro-Mechanical-System (MEMS), and inputting information of a predetermined pattern to the MEMS; and (b) applying said printer head in an injection molding process to form an injection molded product having said predetermined pattern. In the method, the predetermined pattern can be changed by changing the information which is input to the MEMS. This cuts down the number of operating steps required, and reduces costs. Furthermore, the multi-channel ink-jet printer head can operate very precisely under the control of the MEMS. This enhances the operating efficiency. Thus, the method of the present invention can be advantageously applied in mass production facilities.

### BACKGROUND OF THE INVENTION

1. Field of the Invention

The invention relates generally to transfer printing methods, and more particularly to a kind of transfer printing method used in an injection molding process.

2. Description of the Prior Art

In industry, IMD (In-Mold Decoration) printing methods are in widespread use for forming predetermined patterns on a surface of an injection molded product. The method of film transfer printing is popular. In the film transfer printing method, a film is provided. The film comprises a piece of film material, a layer of bonding agent printed on the film material, a layer of color printing printed on the layer of bonding agent, a layer of compound ink printed on the layer of color printing, and a layer of adhesive printed on the layer of compound ink. In use, the film is positioned in a mold, and the air in the mold is pumped out. Thus the film is attached on an inner wall of the mold, with the piece of film material abutting the inner wall. Then, molten material is injected into the mold. During this process, the layer of adhesive of the film melts and adheres to the molten material. Then the molten material is cooled and solidified, thereby forming the injection molded product having the predetermined pattern formed thereon.

U.S. Pat. No. 6,634,291 discloses such kind of printing method. The method comprises the steps of: (1) printing a transparent, heat sensitive bonding agent on a single piece of film material; (2) printing a color print on the layer of bonding agent; (3) printing a compound ink obtained from a mixture of printing ink and heat sensitive bonding agent on the color print; (4) primary baking the printed single piece of film material; (5) printing a layer of adhesive on the layer of compound ink to enable the single piece of printing a layer of adhesive on the layer of compound ink to enable the single piece of film material to be adhered to an injection molded product during the further injection molding process; (6) secondary baking the printed single piece of film material; (7) putting the printed single piece of film material into a steel die of a hot press, and shape-forming the printed single piece of film material, thereby obtaining a semi-finished product after cooling of the steel die; and (8) putting the semi-finished product in an injection molding machine and forming the desired finished product.

The above-described process of manufacturing the film has many steps and is quite complicated. The film must be provided in advance, and the pattern thereon cannot be readily changed. Furthermore, in mass production, one piece of film material is needed for each injection molded product, and the total number of pieces of film material needed is large. These drawbacks reduce operating efficiency and increase costs.

A new transfer printing method for an injection molding process which overcomes the above-mentioned problems is desired.

### BRIEF SUMMARY OF THE INVENTION

Accordingly, an object of the present invention is to provide a transfer printing method which can transfer a predetermined print pattern to an injection molded product efficiently and precisely.

To achieve the above-mentioned object, the present invention provides a transfer printing method for an injection molding process. The method includes the steps of: (a) providing a multi-channel ink-jet printer head comprising a Micro-Electro-Mechanical-System (MEMS), and inputting information of a predetermined pattern to the MEMS; and (b) applying said printer head in an injection molding process to form an injection molded product having said predetermined pattern.

Step (b) comprises the steps of: (b1) providing an injection molded product; and (b2) spraying corresponding amounts of ink with corresponding colors onto said injection molded product using said printer head.

Alternatively, step (b) comprises the steps of: (b1′) positioning a molding board with a predetermined pattern formed thereon on an inner surface of a mold; (b2′) spraying corresponding amounts of ink with corresponding colors onto the molding board at the predetermined pattern using said printer head; and (b3′) forming an injection molded product having the predetermined pattern by an injection molding process.

Compared with a conventional transfer printing method, the transfer printing method of the present invention has the following advantages. Firstly, the predetermined pattern can be changed by changing the information which is input to the MEMS. This cuts down the number of operating steps required, and reduces costs. Secondly, the multi-channel ink-jet printer head can operate very precisely under the control of the MEMS. This enhances the operating efficiency. Thus, the method of the present invention can be advantageously applied in mass production facilities.

Other objects, advantages and novel features of the invention will become more apparent from the following detailed description when taken in conjunction with the accompanying drawing, in which:

### BRIEF DESCRIPTION OF THE DRAWING

FIG. 1 is a flow chart showing a transfer printing method of the present invention.

### DESCRIPTION OF THE PREFERRED EMBODIMENTS

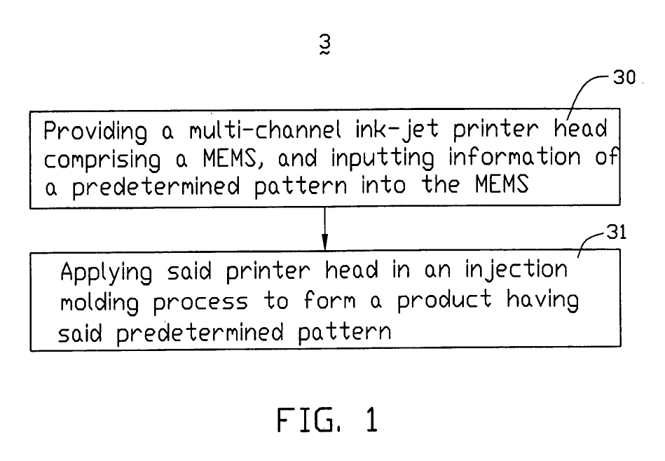

Referring to FIG. 1, a transfer printing method 3 of the present invention comprises the steps of: providing a multi-channel ink-jet printer head comprising a Micro-Electro-Mechanical-System (MEMS), and inputting information of a predetermined pattern to the MEMS (step 30); and applying said printer head in an injection molding process to form an injection molded product having said predetermined pattern (step 31). The injection molded product can be made of plastic, for example.

Step 31 is preferably performed as follows. An injection molded product is provided, and the multi-channel ink-jet printer head sprays ink onto the product directly. Thus, the predetermined pattern is formed on the surface of the product. In the step 31, the multi-channel ink-jet printer head is controlled by a mechanical manipulator. The manipulator is programmed by a computer or a Random Access Memory (RAM). In operation, the manipulator moves the multi-channel ink-jet printer head over the product, and positions the multi-channel ink-jet printer head at a first location. Then the MEMS sends an instruction to the multi-channel ink-jet printer head, the instruction corresponding to information on the predetermined pattern. The multi-channel ink-jet printer head receives the instruction and sprays corresponding amounts of ink with corresponding colors onto the surface of the product directly. After that, the manipulator moves and positions the multi-channel ink-jet printer head at a second location over the product, and the multi-channel ink-jet printer head again executes the ink-spray process. The above-described processes are repeated until the complete predetermined pattern is formed on the surface of the product.

Alternatively, step 31 can be performed as follows. Firstly, in the injection molding process, a molding board with a predetermined pattern formed thereon is positioned on an inner surface of a mold. The molding board is made of at least one of aluminum, copper, iron, and any alloy thereof. The predetermined pattern is formed on the molding board by incising or etching. The mold can comprise separable male and female dies. When the male mold and female mold are separate from each other, the molding board is positioned either on the male die or in the female die. Secondly, the MEMS sends an instruction to the multi-channel ink-jet printer head. The instruction corresponds to information on the predetermined pattern. The multi-channel ink-jet printer head receives the instruction, and sprays corresponding amounts of ink with corresponding colors onto the molding board at the predetermined pattern. Then, the male and female molds are closed together, and molten material is injected into the mold. The molten material is molded to form the injection molded product, with the ink of the molding board attached onto the product. Thus, the product having the predetermined pattern is formed.

In the above-described processes, a manipulator is applied to control the multi-channel ink-jet printer head. Furthermore, the product is taken out of the mold by another manipulator.

Compared with a conventional transfer printing method, the transfer printing method of the present invention adopts the multi-channel ink-jet printer head controlled by a MEMS. This has the following advantages. Firstly, the predetermined pattern can be changed by changing the information that is input to the MEMS. This cuts down the number of operating steps required, and reduces costs. Secondly, the multi-channel ink-jet printer head can operate very precisely under the control of the MEMS. This enhances the operating efficiency. Thus, the method of the present invention can be advantageously applied in mass production facilities.

It is to be understood that the above-described methods are intended to illustrate rather than limit the invention. Variations may be made to the methods without departing from the spirit of the invention. Accordingly, it is appropriate that the appended claims be construed broadly and in a manner consistent with the scope of the invention.

1. A transfer printing method for an injection molding process, the transfer printing method comprising the steps of:
(a) providing a multi-channel ink-jet printer head comprising a Micro-Electro-Mechanical-System (MEMS), and inputting information of a predetermined pattern to the MEMS; and
(b) applying said printer head in an injection molding process to form an injection molded product having said predetermined pattern.

2. The transfer printing method as claimed in claim 1, wherein said printer head is controlled by a manipulator.

3. The transfer printing method as claimed in claim 2, wherein the manipulator is programmed by a computer.

4. The transfer printing method as claimed in claim 2, wherein the manipulator is programmed by a Random Access Memory (RAM).

5. The transfer printing method as claimed in claim 1, wherein step (b) comprises the steps of:
(b1) providing an injection molded product; and
(b2) spraying corresponding amounts of ink with corresponding colors onto said injection molded product using said printer head.

6. The transfer printing method as claimed in claim 1, wherein step (b) comprises the steps of:
(b1′) positioning a molding board with a predetermined pattern formed thereon onto an inner surface of a mold;
(b2′) spraying corresponding amounts of ink with corresponding colors onto the molding board at the predetermined pattern using said printer head; and
(b3′) forming an injection molded product having the predetermined pattern by an injection molding process.

7. The transfer printing method as claimed in claim 6, wherein the molding board is made of at least one of aluminum, copper, iron, and any alloy thereof.

8. The transfer printing method as claimed in claim 6, wherein the mold comprises separable male and female dies.

9. The transfer printing method as claimed in claim 8, wherein step (b3′) comprises the steps of:
(b31′) closing the male and female molds together;
(b32′) injecting molten material into the mold to form the injection molded product with the ink of the molding board attached on the injection molded product; and
(b33′) separating the male and female molds, and taking the injection molded product out from the mold.

10. The transfer printing method as claimed in claim 6, wherein the predetermined pattern is formed on the molding board by incising or etching.

11. The transfer printing method as claimed in claim 1, wherein the product is made of plastic.

12. A method for transferring printing in an injection molding process, comprising the steps of:
providing a programmably controllable printer head in an injection molding system performing said injection molding process; and
transferring said printing via said printer head onto a final product of said injection molding system during said injection molding process to form a predetermined pattern on said final product with said printing.

13. The method as claimed in claim 12, wherein said printer head is a multi-channel ink-jet printer head controlled by a Micro Electro-Mechanical System (MEMS).

14. The method as claimed in claim 12, wherein said printing is transferred to a patterned and uncolored mold installed in dies of said injection molding system by means of applying said printer head on said mold before said final product is formed in said dies.

15. The method as claimed in claim 12, wherein said printing is transferred to said final product via said printer head immediately after said final product is formed in said injection molding system.

16. A method for transferring printing in an injection molding process, comprising the steps of:
providing a programmable Micro Electro-Mechanical System (MEMS) in an injection molding system performing said injection molding process;
installing a printer head controlled by said MEMS in an injection molding system; and
transferring said printing via said printer head onto a final product of said injection molding system during said injection molding process to form a predetermined pattern on said final product with said printing.

17. The method as claimed in claim 16, wherein said pattern is programmed in said MEMS before said transferring step.
